(19) United States
(12) Patent Application Publication
(10) Pub. No.: US 2020/0180597 A1
(43) Pub. Date: Jun. 11, 2020

(54) TEMPERATURE-BASED EMISSIONS STABILITY FLAG FOR HYBRID TORQUE HANDOFF

(71) Applicant: GM GLOBAL TECHNOLOGY OPERATIONS LLC, Detroit, MI (US)

(72) Inventors: Brian P. Hannon, JR., White Hall, MA (US); Daniel S. Dimoski, Royal Oak, MI (US); Timothy Wendling, New Lothrop, MI (US)

(21) Appl. No.: 16/211,497

(22) Filed: Dec. 6, 2018

(51) Int. Cl. B60W 20/16; B60W 10/06; B60W 10/08; B60W 20/40

(52) U.S. Cl. CPC B60W 20/16; B60W 10/06; B60W 10/08; B60W 2710/08; B60W 2400/00; B60W 2710/06; B60W 20/40

(57) ABSTRACT

A system and method to implement a torque handoff between and electric machine and an internal combustion engine in a motor vehicle are provided. To implement the torque handoff without undue delay, temperature of the exhaust gas is taken into consideration to determine whether an emissions stability criterium is met for handing off torque, and if the emissions stability criterium is met, the system and method are configured to handoff torque from the electric machine to the internal combustion engine. When the exhaust gas is sufficiently warm, it may be determined that the engine is operating with sufficiently low levels of hydrocarbons in accordance with emissions regulations, such that torque handoff may be made with confidence of maintaining emissions standards.

### INTRODUCTION

The present disclosure relates to emission-compliant torque handoff from an electric machine to an internal combustion engine in a hybrid motor vehicle.

Vehicle cold start emission reduction strategy is normally implemented during stable engine speed and load conditions. Typically, a hybrid system shelters the internal combustion engine for a predetermined time to allow for catalyst warm-up of a catalytic converter, in order for the catalytic converter to be sufficiently warm enough to efficiently convert hydrocarbons to less harmful compounds. Elevated engine idle and spark retard is performed during the cold start emissions reductions strategy, typically for a predetermined time period, for example, approximately 10 to 20 seconds. After the predetermined time period, catalytic converter light-off has occurred and catalytic converter oxidation and reduction processes are occurring. After catalytic converter light-off has occurred, torque may be handed off from the electric machine to the internal combustion engine in an emission-compliant manner. This is referred to as a sheltered start.

Newer propulsion technologies may necessitate execution of torque handoff to the internal combustion engine before the normal cold start emission reduction strategy is completed. For example, a hybrid system that has a small battery capacity to move the vehicle may require a very short sheltered start. It would then be expected that the vehicle would use the internal combustion engine to implement desired torque levels prior to the normal waiting period for the cold start emission reduction strategy.

Thus, while current vehicle cold start emission reduction strategies achieve their intended purpose, there is a need for a new and improved system and method for implementing a faster torque handoff while complying with emissions standards.

### SUMMARY

The present disclosure provides a physics-based method to determine when torque handoff from the electric machine to the engine may occur in an emission-compliant manner. It has been discovered that the amount of increase in temperature of the exhaust correlates to the amount of fuel enrichment in the combustion chamber. Increase in temperature is an indicator of an amount of raw hydrocarbons being produced by the engine. Hydrocarbon production becomes lower as the engine warms up. By waiting until the engine is warm enough prior to using engine torque to power the vehicle, hydrocarbon levels can be kept within emissions standards by keeping mass air flow through the engine below an air flow threshold until hydrocarbon production is below a certain threshold. Accordingly, the present disclosure provides a system and method whereby temperature of exhaust gases is measured, and the determination of whether to hand off torque is based on the measured exhaust gas temperature. When the engine is warm enough, hydrocarbon levels are below an acceptable threshold, and mass air flow can be increased through the engine without violating emissions standards. Accordingly, torque can be handed off to the engine in an emission-compliant manner.

In one form, which may be combined with or separate from the other forms disclosed herein, a hybrid automotive system is provided that is configured to perform a torque handoff in a motor vehicle. The system includes an internal combustion engine configured to power the motor vehicle in a combustion mode and an electric machine configured to power the motor vehicle in an electric motor mode. A temperature measurement device is configured to measure an operating exhaust temperature of exhaust gas output from the internal combustion engine. A controller is configured to: receive the operating exhaust temperature; determine whether an emissions stability criterium is met based on the operating exhaust temperature; and output an emissions stability flag if the emissions stability criterium is met. The system also includes an actuator configured to perform a torque handoff from the electric machine to the internal combustion engine based on the controller's output of the emissions stability flag.

In another form, which may be combined with or separate from the other forms disclosed herein, a method of performing a torque handoff in a motor vehicle is provided. The method includes determining an operating exhaust temperature of an exhaust gas of an internal combustion engine; determining whether an emissions stability criterium is met based on the operating exhaust temperature; and performing a torque handoff from an electric machine to an internal combustion engine based on the emissions stability criterium being met.

In yet another form, which may be combined with or separate from the other forms disclosed herein, a control system is configured to implement a torque handoff in a motor vehicle. The control system is configured to: determine an operating exhaust temperature of an exhaust gas of an internal combustion engine; determine whether an emissions stability criterium is met based on the operating exhaust temperature; and actuate a torque handoff from an electric machine to an internal combustion engine based on the emissions stability criterium being met.

Additional features may be provided, including but not limited to: the controller, control system, or method being further configured to determine an amount of achieved torque handoff readiness based on the operating exhaust temperature, determine whether the amount of achieved torque handoff readiness exceeds a predetermined threshold, determine whether the emissions stability criterium is met based on whether the amount of achieved torque handoff readiness exceeds the predetermined threshold, and/or determine a startup exhaust temperature and an emission-compliant exhaust gas temperature. The achieved torque handoff readiness may be further based on the startup exhaust temperature and the emission-compliant exhaust gas temperature. The system may include a catalyst configured to convert hydrocarbons within the exhaust gas into other compounds.

Further additional features may be provided, including but not limited to: the emission-compliant exhaust gas temperature being a temperature at which the engine produces no more hydrocarbons than an upper threshold amount of hydrocarbons; the controller, control system, or method being further configured to determine whether the motor vehicle is in a cold start emission control mode; the controller, control system, or method being further configured to determine whether the emissions stability criterium is met when the motor vehicle is in the cold start emission control mode; wherein the motor vehicle is in the cold start emission control mode when the internal combustion engine is operating within a predetermined coolant temperature range; and the torque handoff being initiated in response to the emissions stability flag.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a hybrid vehicle system, in accordance with the principles of the present disclosure;

FIG. 2 is a block diagram illustrating a variation of a method of performing a torque handoff in a motor vehicle, according to the principles of the present disclosure; and

FIG. 3 is a block diagram illustrating another variation of a method of performing a torque handoff in a motor vehicle, according to the principles of the present disclosure.

### DETAILED DESCRIPTION

The following description of one aspect is merely exemplary in nature and is in no way intended to limit the invention, its application, or uses. For purposes of clarity, the same reference numbers will be used in the drawings to identify similar elements. As used herein, activated refers to operation using all of the engine cylinders. Deactivated refers to operation using less than all of the cylinders of the engine (one or more cylinders not active). As used herein, the term processor refers to an application specific integrated circuit (ASIC), an electronic circuit, a module (shared, dedicated, or group) and a memory that together execute one or more software or firmware programs, a combinational logic circuit, or other suitable components that provide the described functionality.

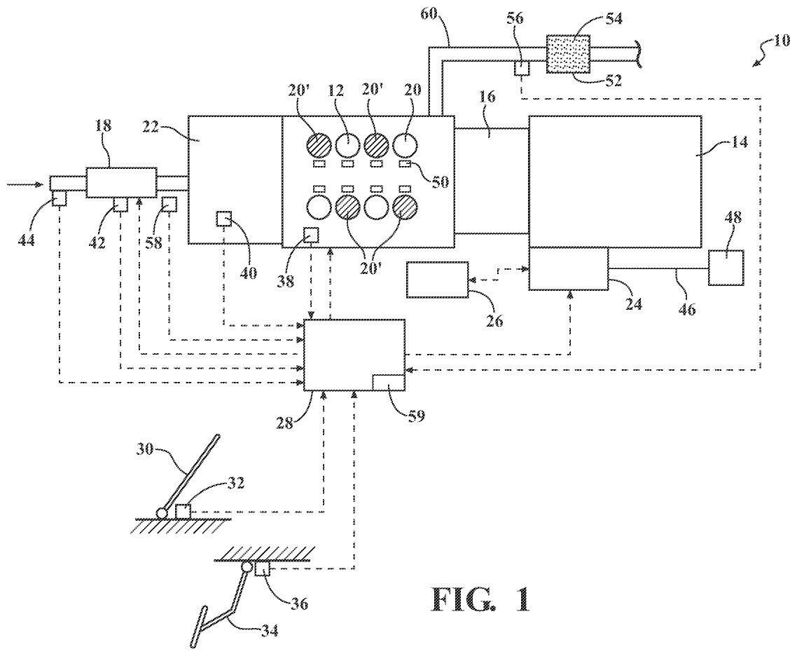

Referring now to FIG. 1, a hybrid vehicle system 10 is provided that includes an internal combustion engine 12 and an electric motor 24, each of which may drive a transmission 14. The transmission 14 may be of any desirable configuration, such as an automatic or a manual transmission, or a continuously variable transmission. In a combustion mode, the transmission 14 is driven by the engine 12 through a corresponding torque converter or clutch 16. Air flows into the engine 12 through a throttle 18. The engine 12 includes N cylinders 20. In some examples, one or more of the cylinders 20 may be selectively deactivated during engine operation. Although FIG. 1 depicts eight cylinders (N=8), it should be appreciated that the engine 12 may include additional or fewer cylinders 20. For example, engines having 4, 5, 6, 8, 10, 12 and 16 cylinders are contemplated. Air flows into the engine 12 through an intake manifold 22 and is combusted with fuel in the cylinders 20.

The electric machine 24 is operable in each of an electric motor mode and a generator mode. In the electric motor mode, the electric machine 24 is powered by a battery 26 and drives the transmission 14. In the generator mode, the electric machine 24 is driven by the transmission 14 and generates electrical energy that is used to charge the battery 26. The battery 26 may also be used to power other vehicle accessories, in addition to the electric machine 24.

A controller 28 communicates with the engine 12 and the electric machine 24 and may receive various inputs from exhaust parameter measurement devices, such as sensors as discussed herein. A vehicle operator manipulates an accelerator pedal 30 to regulate the throttle 18. More particularly, a pedal position sensor 32 generates a pedal position signal that is communicated to the controller 28. The controller 28 generates a throttle control signal based on the pedal position signal. A throttle actuator (not shown) adjusts the throttle 18 based on the throttle control signal to regulate air flow into the engine 12.

The vehicle operator also manipulates a brake pedal 34 to regulate vehicle braking. As the brake pedal 34 is actuated, a brake position sensor 36 generates a brake pedal position signal that is communicated to the controller 28. The controller 28 generates a brake control signal based on the brake pedal position signal. A brake system (not shown) adjusts vehicle braking based on the brake control signal to regulate vehicle speed. In addition to the pedal position sensor 32 and the brake position sensor 36, an engine speed sensor 38 generates a signal based on engine speed. An intake manifold absolute pressure (MAP) sensor 40 generates a signal based on a pressure of the intake manifold 22. A throttle position sensor (TPS) 42 generates a signal based on throttle position. A mass air flow sensor (MAF) 44 generates a signal based on air flow into the throttle 18. A mass fuel flow sensor 58 can also be provided.

When the vehicle load requirements can be met using torque generated by less than all of the cylinders 20, the controller 28 transitions the engine 12 to the deactivated mode. In an exemplary embodiment, N/2 cylinders 20′ are deactivated, although one or more cylinders 20′ may be deactivated. Upon deactivation of the selected cylinders 20′, the controller 28 increases the power output of the remaining cylinders 20 by adjusting the position of the throttle 18. The engine load is determined based on the MAP, MAF, RPM, and other inputs. For example, if an engine vacuum is above a threshold level for a given RPM, the engine load can be provided by less than all cylinders and the engine 12 is operated in the deactivated mode. If the vacuum is below a second threshold level for the given RPM, the engine load cannot be provided by less than all of the cylinders, and the engine 12 is operated in the activated mode.

The controller 28 provides engine speed control to adapt the engine output torque through intake air/fuel and spark timing controls in order to maintain a target engine speed. The controller 28 provides an electronic spark timing (EST) signal output via a line 46 to an ignition controller 48. The ignition controller 48 responds to the EST signal to provide timed output of drive signals to spark plugs 50 for combusting the fuel charge in the engine cylinders 20. The EST signal may also provide spark timing signals over a wide range of timing. Normally, it is desirable that spark timing occur before piston top dead center and, with increasing engine speed it is typical to further advance spark timing.

In some cases, spark timing may occur after-top-dead center. Spark timing may be retarded, for example, to quickly limit engine output torque or during engine cold starts to increase exhaust gas temperature, in essence trading engine output torque for heat.

The exhaust from the engine 12 is discharged through at least one catalytic converter 52, having a catalyst 54 which is required to reach a predetermined temperature (defining “catalyst light-off”) prior to optimally performing its oxidation and reduction reactions. Spark timing may be retarded during engine cold starts to more quickly increase exhaust gas temperature, and therefore to raise the temperature of the catalyst 54 as quickly as possible, thereby more quickly achieving fuel emissions standards. The predetermined temperature defining catalyst light-off may be saved in a memory 59 of the controller 28.

As a further method to raise the temperature of the catalyst 54 during engine cold starts, an “elevated idle” may be performed, wherein the controller 28 signals for a temporarily increased engine idle speed above the normal engine idle speed. The elevated idle may extend for a period of approximately 10 to 40 seconds after engine start. A set target is used to control engine rpm and spark timing or retard during elevated idle operation.

During certain operational times the full period to perform elevated idle may not be available. For example, if the vehicle accelerates using the electric machine 24 powered by the battery 26 to drive the transmission 14, but there is insufficient torque to meet the torque demand, an engine start and torque output may be required before the catalyst 54 can reach the minimum required temperature for catalyst light-off. Under such conditions, it is desirable to continue to achieve emission standards while the engine speed comes up to meet torque demand.

However, if possible, it is desirable to hand off torque from the electric machine 24 to the engine 12 quickly, as soon as the amount of ultimately emitted hydrocarbons are under a threshold level sufficient to meet emissions standards. To determine when such torque handoff from the electric machine 24 to the engine 12 can occur while meeting emissions standards, one or more exhaust temperature sensors 56 may be used, which can be positioned either upstream or downstream or both upstream and downstream of the catalytic converter 52.

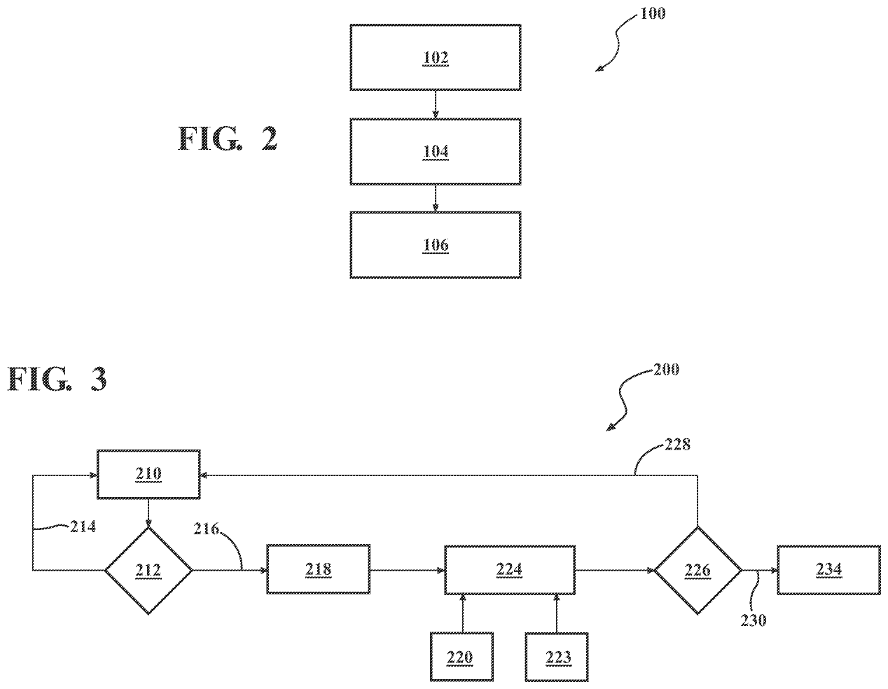

Referring to FIG. 2 and with continued reference to FIG. 1, a high-level version of a method of performing a hybrid torque handoff from the electric machine 24 to the engine 12 is illustrated and generally designated at 100. The method 100 may be implemented by the controller 28, or another controller or combination of controllers, to implement a torque handoff within the hybrid vehicle system 10. The method 100 includes a step 102 of determining an operating exhaust temperature of an exhaust gas of the engine 12. For example, the temperature sensor 56 may be used to measure the exhaust temperature within the exhaust pipe 60 extending from the engine 12 through the catalytic converter 52. In other variations, the exhaust temperature could be estimated using other parameters, as opposed to being directly measured.

The method 100 further includes a step 104 of determining whether an emissions stability criterium is met based on the operating exhaust temperature. In general, the engine emits fewer hydrocarbons, and fewer than a threshold level of hydrocarbons to meet emissions standards, when the exhaust gas is at relatively higher temperatures and/or is increasing at a lower rate. The temperature of the exhaust gas depends on a variety of factors, such as ambient temperature and length of time that the vehicle has been running or was parked before being started. Therefore, the amount of hydrocarbons produced can be predicted based on exhaust gas temperature, but the time it takes to sufficiently warm up the exhaust gas will vary. A model of the hydrocarbon production as a function of operating exhaust temperature may be included in the controller 28, by way of example. Accordingly, determination of the readiness of the exhaust system for torque handoff is made based on the operating exhaust gas temperature.

The method 100 then includes a step 106 of performing a torque handoff from the electric machine 24 to the internal combustion engine 12 based on the emissions stability criterium (temperature-based criterium) being met.

Referring now to FIG. 3, with continued reference to FIG. 1, a more detailed version of a method for performing a hybrid torque handoff from an electric machine 24 to an engine 12 is illustrated and generally designated at 200. As with the method 100, the method 200 may be implemented by the controller 28, or another controller or combination of controllers, to implement a torque handoff within the hybrid vehicle system 10.

The method includes a step 210 of collecting parametric data for determining whether the hybrid automotive system 10 of the motor vehicle is in a cold start emission control (CSEC) mode. For example, data collected may include the engine speed and the spark timing. In step 212, the method 200 includes determining whether the motor vehicle is in the CSEC mode. In some examples, the motor vehicle, or the hybrid system 10, may be determined to be in the CSEC mode when the internal combustion engine 12 is operating within a predetermined coolant temperature range. In some cases, the CSEC mode may also be implemented in certain ranges of determined catalyst temperature (e.g., based on estimating the catalyst temperature through other measured parameters), or when the engine 12 is operating below a predetermined engine speed, such as 1500 rpm, and/or in a predetermined ignition angle range, such as less than −10 degrees. The ignition angle range is the point at which spark in the combustion chamber occurs with respect to top dead center. The CSEC mode is a condition in which the catalytic converter 52 is at a temperature below that required for catalytic light-off, for example, when the catalytic converter 52 is at an ambient temperature.

If the hybrid system 10 of the motor vehicle is not in the CSEC mode, the engine 12 is already warm and the method 200 follows path 214 back to block 210 to continue to collect data and determine again whether the vehicle is in the CSEC mode. If, however, the vehicle is in the CSEC mode, the method 200 proceeds along path 216 to a step 218.

In step 218, the method 200 includes determining an operating exhaust temperature, for example, with the temperature sensor 56. The method 200 or control system then proceed to a step 224, which includes calculating a percentage of achieved torque handoff readiness; in other words, the amount of torque handoff readiness indicates how ready the hybrid system is to handoff torque to the engine 12 based on amount hydrocarbon emissions being emitted from the engine 12, where the amount of hydrocarbon emissions is approximately known based on the determined operating exhaust gas temperature.

In one example, to calculate the percentage of achieved torque handoff readiness, several inputs are used. For example, the operating exhaust temperature determined in step 218 is used to calculate the percentage of achieved torque handoff readiness. In addition, as shown by step or block 220, the method 200 includes determining an initial exhaust gas temperature, where the initial exhaust gas temperature may be determined when the engine 12 is started. Thus, the step 220 represents a data point of temperature information that is measured at an earlier point in time, but that is input to the step or module 224. Another input to the calculation of the percentage of achieved torque handoff readiness is an emission-compliant exhaust gas temperature, which may be determined in block or step 223 and provided to the block or step 224. The emission-compliant exhaust gas temperature is a temperature at which the engine 12 produces no more hydrocarbons than an upper threshold amount of hydrocarbons. The emission-compliant exhaust gas temperature may be preprogrammed or calibrated into the controller 28, by way of example. Thus, in this example, the block or step 224 may determine the percentage of achieved torque handoff readiness with the following equation:

$$Percent of Achieved Torque Handoff Readiness = \frac{{T}_{C} - {T}_{0}}{{T}_{H} - {T}_{0}} ⋆ 100 \% \qquad ( 1 )$$

where T_{C} is the operating (or current) exhaust temperature, T₀ is the initial exhaust gas temperature, and T_{H} is the emission-compliant exhaust gas temperature. Thus, the method 200 includes determining the amount of achieved torque handoff readiness based on the operating exhaust temperature T_{C}, and determining the amount or percentage of achieved torque handoff readiness may be further based on the initial exhaust temperature T₀ and the emission-compliant exhaust gas temperature T_{H}.

The method 200 then proceeds to a step 226 of determining whether the amount of achieved torque handoff readiness exceeds a predetermined threshold. The predetermined threshold for torque handoff readiness, using equation (1), may be, for example, 100%. The step 226 may also include determining whether the emissions stability criterium is met based on whether the amount of achieved torque handoff readiness exceeds the predetermined threshold.

If the amount of achieved torque handoff readiness does not exceed the predetermined threshold, the method 200 follows path 228 back to step 210. However, if the amount of achieved torque handoff readiness does achieve or exceed the predetermined threshold, then the method 200 proceeds to along path 230 to step 234. In the example of FIG. 3, determining whether the emissions stability criterium is met is only performed when the motor vehicle is in the cold start emission control (CSEC) mode, as determined in step 212. The method 200 may also include outputting an emissions stability flag when the emissions stability criterium is met, and then proceeding to step 234.

In step 234, the method 200 includes actuating a torque handoff from the electric machine 24 to the internal combustion engine 12 based on the emissions stability criterium being met. When the emissions stability flag is used, the step 234 of performing the torque handoff is initiated in response to the emissions stability flag.

The system and method disclosed herein for performing a hybrid torque handoff offers several advantages. These include the ability to hand off torque according to conditions, rather than using a predetermined waiting period, which speeds up torque handoff under certain conditions. The present system and method is physics-based and may use a model to project hydrocarbon emissions performance as a function of operating exhaust temperature, allowing for an appropriate handoff of torque to the internal combustion engine 12 based on the operating exhaust temperature.

The controller 28 is a control system including one or more controllers and may include a computer-readable medium (also referred to as a processor-readable medium), including any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

The description of the present disclosure is merely exemplary in nature and variations that do not depart from the gist of the present disclosure are intended to be within the scope of the present disclosure. The various examples given may be combined in a variety of ways without falling beyond the spirit and scope of the present disclosure.

What is claimed is:

1. A hybrid automotive system configured to perform a torque handoff in a motor vehicle, the system comprising:
an internal combustion engine configured to power the motor vehicle in a combustion mode;
an electric machine configured to power the motor vehicle in an electric motor mode;
a temperature measurement device configured to measure an operating exhaust temperature of exhaust gas output from the internal combustion engine;
a controller configured to:
receive the operating exhaust temperature;
determine whether an emissions stability criterium is met based on the operating exhaust temperature; and
output an emissions stability flag if the emissions stability criterium is met; and
an actuator configured to perform a torque handoff from the electric machine to the internal combustion engine based on the controller's output of the emissions stability flag.

2. The hybrid automotive system of claim 1, the controller being further configured to:
determine an amount of achieved torque handoff readiness based on the operating exhaust temperature;
determine whether the amount of achieved torque handoff readiness exceeds a predetermined threshold; and
determine whether the emissions stability criterium is met based on whether the amount of achieved torque handoff readiness exceeds the predetermined threshold.

3. The hybrid automotive system of claim 2, wherein the controller is further configured to determine a startup exhaust temperature and an emission-compliant exhaust gas temperature, the amount of achieved torque converter readiness being further based on the startup exhaust temperature and the emission-compliant exhaust gas temperature.

4. The hybrid automotive system of claim 3, wherein the emission-compliant exhaust gas temperature is a predetermined temperature at which the engine produces no more hydrocarbons than an upper threshold amount of hydrocarbons.

5. The hybrid automotive system of claim 4, wherein the controller is further configured to determine whether the motor vehicle is in a cold start emission control mode, the controller being configured to determine whether the emissions stability criterium is met when the motor vehicle is in the cold start emission control mode.

6. The hybrid automotive system of claim 5, wherein the motor vehicle is in the cold start emission control mode when the internal combustion engine is operating within a predetermined coolant temperature range.

7. A method of performing a torque handoff in a motor vehicle, the method comprising:
determining an operating exhaust temperature of an exhaust gas of an internal combustion engine;
determining whether an emissions stability criterium is met based on the operating exhaust temperature; and
performing a torque handoff from an electric machine to an internal combustion engine based on the emissions stability criterium being met.

8. The method of claim 7, further comprising outputting an emissions stability flag when the emissions stability criterium is met, the step of performing the torque handoff being initiated in response to the emissions stability flag.

9. The method of claim 8, further comprising:
determining an amount of achieved torque handoff readiness based on the operating exhaust temperature;
determining whether the amount of achieved torque handoff readiness exceeds a predetermined threshold; and
determining whether the emissions stability criterium is met based on whether the amount of achieved torque handoff readiness exceeds the predetermined threshold.

10. The method of claim 9, further comprising determining a startup exhaust temperature and an emission-compliant exhaust gas temperature, the step of determining the amount of achieved torque handoff readiness being further based on the startup exhaust temperature and the emission-compliant exhaust gas temperature.

11. The method of claim 10, the emission-compliant exhaust gas temperature being a predetermined temperature at which the engine produces no more hydrocarbons than an upper threshold amount of hydrocarbons.

12. The method of claim 11, further comprising determining whether the motor vehicle is in a cold start emission control mode, the step of determining whether the emissions stability criterium is met being performed when the motor vehicle is in the cold start emission control mode.

13. The method of claim 12, further comprising determining that the motor vehicle is in the cold start emission control mode when the internal combustion engine is operating within a predetermined coolant temperature range.

14. A control system configured to implement a torque handoff in a motor vehicle, the control system being configured to:
determine an operating exhaust temperature of an exhaust gas of an internal combustion engine;
determine whether an emissions stability criterium is met based on the operating exhaust temperature; and
actuate a torque handoff from an electric machine to an internal combustion engine based on the emissions stability criterium being met.

15. The control system of claim 14, the control system being further configured to output an emissions stability flag when the emissions stability criterium is met and to actuate the torque handoff in response to the emissions stability flag.

16. The control system of claim 14, the control system being further configured to:
determine an amount of achieved torque handoff readiness based on the operating exhaust temperature;
determine whether the amount of achieved torque handoff readiness exceeds a predetermined threshold; and
determine whether the emissions stability criterium is met based on whether the amount of achieved torque handoff readiness exceeds the predetermined threshold.

17. The control system of claim 16, the control system being further configured to determine a startup exhaust temperature and an emission-compliant exhaust gas temperature, and to determine the amount of achieved torque handoff readiness further based on the startup exhaust temperature and the emission-compliant exhaust gas temperature.

18. The control system of claim 17, the emission-compliant exhaust gas temperature being a predetermined temperature at which the engine produces no more hydrocarbons than an upper threshold amount of hydrocarbons.

19. The control system of claim 18, the control system being further configured to determine whether the motor vehicle is in a cold start emission control mode, and to determine whether the emissions stability criterium is met when the motor vehicle is in the cold start emission control mode.

20. The control system of claim 19, the control system being configured to determine that the motor vehicle is in the cold start emission control mode when the internal combustion engine is operating within a predetermined coolant temperature range.
